(19) United States
(12) Patent Application Publication
(10) Pub. No.: US 2026/0192227 A1
(43) Pub. Date: Jul. 9, 2026

(54) FILTER ELEMENT FOR ARRANGEMENT IN A FILTER HOUSING OF A FILTER DEVICE, FILTER HOUSING AND FILTER DEVICE

(71) Applicant: MANN+HUMMEL GmbH, Ludwigsburg (DE)

(72) Inventors: Klaus-Dieter RUHLAND, Meckenheim (DE); Michael KAUFMANN, Meckenheim (DE)

(21) Appl. No.: 19/559,379

(22) Filed: Mar. 6, 2026

Related U.S. Application Data
(63) Continuation of application No. PCT/EP2024/072811, filed on Aug. 13, 2024.

(30) Foreign Application Priority Data
Sep. 13, 2023 (DE) 10 2023 124 737.9

(51) Int. Cl. B01D 46/00; B01D 46/24

(52) U.S. Cl. CPC B01D 46/0005; B01D 46/2403; B01D 2265/06; B01D 2271/02

(57) ABSTRACT

A filter element has a filter medium body with inflow side and outflow side at opposite sides relative to a longitudinal center axis of the filter element. A circumferential seal at the filter medium body extends around the longitudinal center axis. At least two projection regions being part of one or more projection elements are arranged at a radially outer side of the filter element axially between the circumferential seal and the outflow side. At least one projection region is closer to the circumferential seal than at least one other projection region and arranged at a larger radial distance to the longitudinal center axis than the other projection region. When connected in a filter housing, the projection regions are placed against a mating structure of the filter housing to form an axial stop of the filter element in the filter housing relative to the longitudinal center axis.

### CROSS-REFERENCE TO RELATED APPLICATIONS

This application is a continuation application of international application No. PCT/EP2024/072811 having an international filing date of August 13, 2024, and designating the United States, the international application claiming a priority date of September 13, 2023, based on prior filed German patent application No. 10 2023 124 737.9, the entire contents of the aforesaid applications being incorporated herein by reference to the fullest extent permissible.

### BACKGROUND

The invention concerns a filter element, for example air filter element, for arrangement in a filter housing of a filter device, for example of an air filter device, including at least one filter medium body with an inflow side and an outflow side at oppositely positioned axial sides in relation to a longitudinal center axis and a circumferential seal in relation to the longitudinal center axis which is arranged at the at least one filter medium body,

wherein the filter element includes at least two projection regions which are part of at least one projection element and which are arranged at a radially outer side of the filter element axially between the circumferential seal and the outflow side of the filter element,

wherein the at least two projection regions are axially spaced apart, and

wherein at least one of the projection regions of the at least two projection regions, which is positioned closer to the circumferential seal than at least one other projection region of the at least two projection regions, is arranged at a larger radial distance to the longitudinal center axis than the at least one other projection region.

Furthermore, the invention concerns a filter housing, for example air filter housing, in which at least one filter element, for example at least one air filter element, may be arranged.

Furthermore, the invention concerns a filter device, for example an air filter device, including at least one filter housing and at least one filter element which is arranged in the at least one filter housing.

US 2018/0169555 A1 discloses a filter system. The filter system includes a filter housing that is realized in the form of a cover and of a housing body. The filter system includes a filter element which is arranged fluidically between the cover and the housing body. The filter system serves for filtering contaminated fluid which enters through an inlet and exits as clean fluid through an outlet. The filter element is mounted exchangeably and removably in the filter housing so that, when it is used up, it may be serviced or replaced by a new clean filter element. A seal arrangement interacts with one or a plurality of housing components in order to prevent that dirty fluid bypasses the filter element and in particular its filter media. The seal arrangement is rectangular and includes a preform element in the form of a preform frame element (also referred to as rim frame) and a housing seal element. The housing seal element is attached to the frame element and defines a housing seal surface which is an axial seal surface in this embodiment. The housing seal surface is pressed axially into a part of the housing body in order to form a seal in the installed state.

The invention has the object to design a filter element, a filter housing, and a filter device of the aforementioned kind in which the filter element as a whole may be designed in a more space-saving manner.

### SUMMARY

The object is solved according to the invention for the filter element in that the at least two projection regions, in an intended connection state of the filter element in a filter housing, may be placed against at least one corresponding mating structure of the filter housing in order to form an axial stop of the filter element in the filter housing in relation to the longitudinal center axis.

According to the invention, at least two projection regions are provided which are arranged at different radial distances to the longitudinal center axis and at different axial distances. In this manner, the projection regions may support the filter element at a mating support surface which is inclined in relation to the longitudinal center axis and which is part of a mating structure of the filter housing. This graduated arrangement of projection regions which define an inclined support surface, viewed radially in relation to the longitudinal center axis, requires less space than an arrangement of projection regions in a surface perpendicular to the longitudinal center axis. The installation space gained by the graduated arrangement of the projection regions in accordance with the invention may be used for the filter medium body. Thus, a larger filter surface area may be realized in the same installation space.

Since the at least two projection regions are arranged axially between the circumferential seal and the outflow side of the filter element, a seal region and a holding region of the filter element in the filter housing may be decoupled. The filter element is held axially in the filter housing by the at least two projection regions. In this manner, it is possible to use a seal that at least partially seals radially.

The at least two projection regions are axially spaced apart. This means that the at least two projection regions are axially spaced apart, viewed in relation to the longitudinal center axis in a projection perpendicular to the longitudinal center axis.

The filter element, in a direction transverse to the longitudinal center axis, includes an approximately round, round-oval or oval outer cross section. The filter element may be referred to as so-called “round filter element”. The filter element may be used in round air filters and/or in compact air filters. In case of compact air filters, the filter element may be used in a single-stage or two-stage embodiment. The filter element may be combined with at least one cyclone separator. By means of a cyclone separator, particles, for example dust particles, may be separated from a gas, for example from the air. The at least one cyclone separator may be used as a pre-separator.

In this way, the medium to be cleaned, for example air, may be pre-cleaned before it flows through the filter element. In this manner, a two-stage separation may be realized. The at least one cyclone separator may be fastened for example with toggle fasteners at the filter housing with the filter element. The at least one cyclone separator may thus be pressed in axial direction against the filter housing. In this manner, the filter element may be axially held in position in relation to the longitudinal center axis in the filter housing by the cyclone separator. By means of the circumferential seal, a region between the filter element, the filter housing, and the cyclone separator may be sealed. A force flow may be realized via the cyclone separator to a frame element of the filter element and from there to the filter housing. In this context, the force introduction into the filter housing may be realized via lateral ribs at the frame element of the filter element.

The filter element may be arranged axially in relation to the longitudinal center axis in a filter housing. The filter element may be clamped axially in the filter housing. The at least two projection regions may contact thus in axial direction the at least one corresponding mating structure of the filter housing. The filter element may thus be supported at the at least one mating structure.

By means of the seal, an ingress of particles or water to the clean side between the at least one filter element and the filter housing may be prevented. In addition, an ingress of particles or water in a region between the at least one filter element and the second housing part, for example an immersion tube plate and/or a cyclone block, may be prevented.

The at least one filter medium body may include at least one filter bellows, for example at least one single bellows and/or at least one double bellows.

The filter medium body may include a filter medium, for example filter paper, filter nonwoven, filter foam or the like, suitable for filtering gaseous media, for example air.

The filter medium of the at least one filter medium body may be folded or wound. In this manner, the active filter surface area may be enlarged. The filter element may be designed correspondingly as a folded filter element or as a wound filter element.

The at least one filter element may be a compact filter element, a hollow filter element, a flat filter element or the like.

The filter medium body may include for example a zigzag-shaped folded filter medium with deep folds. In case of an approximately cuboid or prismatic filter medium body, one speaks of deep folds for example when a fold height is approximately at least as large as the expansion in direction of the fold edges and/or in direction transverse to the fold edges.

A hollow filter element is characterized in that it includes at least one element interior which is surrounded by filter medium.

The hollow filter element may be for example a so-called round filter element with a round cross section, an oval round filter element with an oval cross section, a flat-oval round filter element with a flattened oval cross section, a conical round filter element in which the round cross section tapers in axial direction in relation to a main axis, a conical oval round filter element in which the oval cross section tapers in axial direction at least in direction of a transverse axis, a conical flat oval round filter element in which the flat oval cross section tapers in axial direction at least in direction of a transverse axis, or a hollow filter element with a different, for example an angular, cross section and/or a different axial cross section course in direction of an element axis.

The filter device and the filter element may be used in vehicles, for example motor vehicles, in construction and/or agricultural machines, in compressors, in connection with combustion engines, and in cathode filters, for example in connection with fuel cells.

The medium to be purified may be air. In this case, the filter device may also be referred to as air filter device. By means of the filter device, solid or liquid particles, for example dust, may be removed from the gaseous medium.

The longitudinal center axis extends in length direction of the filter device. The length direction of the filter device is the direction in which the components of the filter device are assembled. The longitudinal center axis extends centrally approximately at the middle through the filter device.

The longitudinal center axis may coincide with a housing axis of the filter housing, an installation/removal axis of the filter element in a first housing part, for example in a housing pot, a connection axis of the first housing part with a second housing part, for example with a cyclone housing, and/or an element axis of the filter element. When in the description “radial”, “coaxial”, “axial”, “tangential”, “circumferential”, “concentric”, “eccentric” or the like is mentioned, this relates to the longitudinal center axis, if nothing to the contrary is disclosed. In this context, “circumferential” relates to a virtual wall surface which surrounds the longitudinal center axis.

In an embodiment, at least two of the projection regions may be arranged at the same projection element, for example, wherein at least two of the projection regions at the same projection element may pass into each other without a gap. In this manner, a larger mechanical stability may be realized.

At least two of the projection regions may pass into each other without a gap. In this manner, simpler tools may be employed for producing the projection elements.

A projection element may include a plurality of projection regions. The projection regions may be selected to be randomly small. In this way, a contact region between the projection region and the mating structure of the filter housing may be reduced. Any number of arbitrarily small projection regions may be realized at a projection element. In this manner, a more uniform support may be realized.

A projection element may include innumerable projection regions which are correspondingly small, respectively. In this manner, a real contiguous support surface may be realized. The support surface may be formed of a plurality of projection regions which pass into each other without a gap.

The prefix “projection” in the terms projection element and projection region means that the corresponding element or the region in relation to neighboring regions protrudes, i.e., projects.

In a further embodiment, at least two of the projection regions, viewed in relation to the longitudinal center axis along the circumference, may be tangentially spaced apart. In this manner, the projection regions may be arranged distributed along the circumference. In this manner, a better force transmission between the projection regions and the mating structure of the filter housing may be realized. For example, at least two of the projection regions, viewed in a projection in direction of the longitudinal center axis, may be tangentially spaced apart in relation to the longitudinal center axis.

In a further embodiment, the filter element may include at least two projection elements, wherein at each one of the at least two projection elements at least one of the at least two projection regions is arranged, respectively. In this manner, the projection elements and the projection regions may be adapted more individually to the corresponding mating structure of the filter housing.

In a further embodiment, at least two of the at least two projection regions may include at least one support surface, for example at least one planar support surface which extends at an incline in relation to the longitudinal center axis. In this manner, the projection regions may be supported uniformly at a corresponding mating surface of the mating structure of the filter housing. The mating surface of the mating structure may extend correspondingly inclined in relation to the longitudinal center axis.

The support surface may be planar. In this manner, a more uniform support may be realized.

In a further embodiment, the at least one support surface may be inclined at an acute angle relative to the axial direction of the at least one longitudinal center axis. In this manner, the at least one support surface may serve additionally as an insertion aid, when installing the filter element in the filter housing.

The acute angle may be located at the side which is facing the inflow side. In this manner, the filter element, with the outflow side leading in axial direction in relation to the longitudinal center axis, may be inserted more easily into the filter housing.

In a further embodiment, the support surface may be at least partially contiguous and/or at least partially interrupted. With a contiguous support surface, a better mechanical force transmission may be realized. An interrupted support surface may be realized with a reduced material expenditure.

The support surface may be virtual at least in sections. In this case, the real support action may be realized only with the projection regions. The arrangement of the projection regions along the at least partially virtual support surface enables a uniform support action and prevents tilting or rotation of the filter element relative to the filter housing.

In a further embodiment, at least one projection element may include as a whole a higher mechanical stiffness than the circumferential seal. In this manner, the transmission of the mechanical holding force between the filter element and the filter housing may be decoupled better from the circumferential seal.

At least one projection element may be at least partially flexible. In this manner, a better tolerance compensation upon installation of the filter element in the filter housing may be realized. At least one projection element may include at least partially the same material as the circumferential seal. In this manner, a manufacturing process may be simplified.

At least two projection regions may be arranged distributed across an outer circumference of the filter element. In this manner, the projection regions may support the filter element at the circumferential side at the mating structure of the filter housing.

In a further embodiment, at least one of the projection regions, for example all projection regions, viewed in the axial projection, may be arranged between the longitudinal center axis and a radially outer side of the circumferential seal, for example, wherein the circumferential seal in the axial projection may extend radially outside of the at least one projection region. In this manner, the projection regions may be arranged in a space-saving manner in a section that is tapered in relation to a seal region of the filter housing.

In a further embodiment, the filter element may include at least three circumferentially interrupted support surfaces which are distributed around an outer circumference of the filter element and are facing the outflow side, wherein each of the support surfaces may be defined by at least two of the at least two projection regions. respectively. In this manner, the filter element may be supported uniformly at a mating structure of the filter housing.

The at least three circumferentially interrupted support surfaces in the intended connection state may be positioned at the corresponding mating structure of the filter housing in order to provide an axial stop of the filter element.

The at least three circumferentially interrupted support surfaces may be inclined at an acute angle relative to the axial direction of the longitudinal center axis. In this manner, the support surfaces may serve additionally as insertion aids upon insertion of the filter element into the filter housing.

The circumferential seal may extend radially outside of the at least three circumferentially interrupted support surfaces. In this manner, the support surfaces may be arranged in a region of the filter housing which is reduced in relation to a seal region where the circumferential seal of the filter element is resting.

In a further embodiment, the at least one projection element may be realized at a frame element of the filter element. In this manner, the holding forces may be transmitted from the at least one projection element directly to the frame element. The at least one filter medium body and/or the at least one circumferential seal may thus be kept away from holding forces.

The at least one projection element may be realized as one piece together with the frame element of the filter element. In this manner, the manufacture may be simplified.

In a further embodiment, the circumferential seal may be fastened directly or indirectly to the at least one filter medium body. In case of a direct attachment, additional components are obsolete. An indirect attachment enables a flexible configuration of the at least one filter medium body and/or of the circumferential seal.

The circumferential seal may be attached to at least one frame element of the filter element. In this manner, the circumferential seal may be held stably at the filter element.

The circumferential seal may be attached to one section of at least one frame element of the filter element which is inclined, for example extends at an acute angle in relation to the longitudinal center axis. Due to the inclined extension, the insertion of the circumferential seal into a seal region of the filter housing may be facilitated.

The circumferential seal in relation to the longitudinal center axis may be fastened radially outwardly in relation to a section of at least one frame element of the filter element. In this manner, the circumferential seal may be supported radially inwardly by the at least one frame element.

The circumferential seal may be realized as a multi-component assembly, for example as a two-component assembly, with at least one frame element. In this manner, the manufacture may be simplified. The circumferential seal may be realized together with the at least one frame element by means of an injection process. In this manner, the at least one frame element and the circumferential seal may be designed individually.

The circumferential seal may be produced as a separate part and, once manufactured, connected to at least one frame element, for example by tying in, gluing, welding or the like. In this manner, the at least one frame element and the circumferential seal may be individually produced separate from each other, respectively.

The at least one filter medium body may be connected, for example by casting, to at least one frame element by means of a casting compound, for example a casting compound including or included of polyurethane (PUR). In this manner, the at least one filter medium body may be connected seal-tightly to the at least one frame element.

The filter element may include at least one frame element with a support grid by means of which the at least one filter medium body is supported. In this manner, the mechanical stability of the filter element may be further improved.

The frame element may be less flexible than the circumferential seal. In this manner, by means of the frame element a support function and by means of the seal a better deformability may be realized. Due to the better deformability, the sealing action may be improved by means of the seal. In this context, the different flexibility may be realized by means of different materials and/or by means of different shaping.

The frame element may be formed of a mechanically harder material than the circumferential seal. In this manner, the frame element may be designed to be less flexible than the seal. The material may be a single material or a material mixture, for example a composite material.

As an alternative or in addition, the frame element may be realized at least in sections with the same material as the seal, for example from sealing material. In this manner, a connection of the frame element and of the seal may be improved. Different mechanical stability may then be realized by a corresponding shaping and/or size and/or density of the seal and of the frame element.

As an alternative or in addition, the frame element and the seal may be realized as a multi-component assembly, for example a two-component assembly. In this manner, a manufacture may be simplified.

The seal and the frame element may be produced according to a multi-component injection molding method, for example a two-component injection molding method.

As an alternative or in addition, the seal may include or be included of elastic material. In this manner, the seal may be elastically deformed. In this way, the sealing action may be further improved. An elastic seal may be produced simply from an elastomer, for example foamed elastomer.

As an alternative or in addition, the frame element may include or be included of plastic material. In this manner, a stable and lightweight frame element may be realized. A hard and robust frame element may be realized from injection moldable hard plastic material simply by means of injection molding. By means of injection molding, complex shapes for the frame element may be realized also.

In a further embodiment, the circumferential seal may be designed such that the latter, in an intended state of use in which the filter element is arranged in a filter housing, at least partially acts to seal radially. In this manner, the sealing action may be realized to be less dependent on an axial position of the filter element in the filter housing. In combination with the axial support of the projection regions in relation to the mating structure of the filter housing, the holding function may be decoupled from the sealing function in this way. The circumferential seal thus has no influence on the axial support of the filter element in the filter housing and vice versa.

In a further embodiment, the circumferential seal may include at least one seal lip, for example the circumferential seal may be a lamellar seal. In this manner, the required installation force for installing the filter element in the filter housing may be reduced. The at least one seal lip, for example the at least one lamella, may elastically yield in axial direction in relation to the longitudinal center axis upon installation of the filter element. Due to the relatively filigree structure, for example due to the at least one seal lip or due to the at least one lamella, and the geometric configuration of the circumferential seal, a sealing gap may be bridged without compression of the basic material of the seal. The circumferential seal may be loaded substantially by bending, for example by bending of the at least one seal lip, for example of the at least one lamella. In this manner, a compression of the seal may be reduced.

The circumferential seal, for example the at least one seal lip or the at least one lamella, may seal in relation to a housing wall of the filter housing. In this manner, a radial sealing action in relation to the longitudinal center axis may be realized.

In a further embodiment, the circumferential seal may project past the inflow side of the at least one filter medium body in axial direction. In this manner, a sealing action in relation to a housing interior may be realized also beyond the inflow side.

In a further embodiment, the circumferential seal may be supported at its radially inner circumferential side by a seal holding wall. In this manner, a radial support force for the seal may be realized at its rear side.

The seal holding wall may be connected to at least one of the at least two projection elements in a force-transmitting way. In this manner, the mechanical stability of the filter element may be increased on the side with the seal holding wall and the projection elements.

Furthermore, the object is solved according to the invention for the filter housing in that at least one filter element according to the invention may be arranged in the filter housing.

The filter housing may include at least one mating structure at which at least one projection region of a filter element may be supported in an intended connection state. The at least one mating structure may include at least one mating support surface which extends at an incline in relation to the longitudinal center axis. In this manner, an inclined support surface, realized with projection regions of the filter element, may be supported uniformly at the at least one mating structure. Inclined mating support surfaces require, viewed radially in relation to the longitudinal center axis, less space than surfaces which extend perpendicularly to the longitudinal center axis.

The at least one mating support surface may be inclined at an acute angle in relation to the axial direction of the at least one longitudinal center axis. In this manner, the at least one mating support surface may serve additionally as an insertion aid when installing the filter element in the filter housing.

Furthermore, the object according to the invention is solved for the filter device in that the filter device includes at least one filter element according to the invention.

As a whole, the construction of the filter device according to the invention enables a simple mounting of the at least one filter element, without force action into the filter housing. Clamping of the circumferential seal may be realized, even in an automated fashion, by an axial clamping of a first housing part, for example a housing pot, to a second housing part, for example a cyclone housing. For this purpose, a lever action of suitable closure elements may be utilized.

In other respects, the features and advantages disclosed in connection with the filter element according to the invention, the filter housing according to the invention, and the filter device according to the invention and their respective embodiments apply correspondingly among each other and vice versa. The individual features and advantages can, of course, be combined among each other, wherein further effects may result which go beyond the sum of the individual effects.

### BRIEF DESCRIPTION OF THE DRAWINGS

Further advantages, features, and details of the invention result from the following description in which embodiments of the invention will be explained in more detail with the aid of the accompanying drawings. A person of skill in the art will expediently consider the features disclosed in combination in the drawing figures and the description also individually and combine them to expedient further combinations.

FIG. 1 shows a side view of a filter device for gaseous media with a main filter element and a cyclone block.

FIG. 2 shows a rear view of the filter device of FIG. 1 with viewing direction onto an outlet socket.

FIG. 3 shows a longitudinal section of the filter device of FIG. 1 in a first section plane.

FIG. 4 shows a detail view of the longitudinal section of the filter device of FIG. 3 in the region of a seal of the main filter element.

FIG. 5 shows a longitudinal section of the filter device of FIG. 1 in a second section plane which extends perpendicularly to the first section plane of FIG. 3.

FIG. 6 shows a detail view of the longitudinal section of the filter device of FIG. 5 in the region of the seal of the main filter element.

FIG. 7 shows a view of the inflow side of the main filter element of the filter device of FIG. 1.

FIG. 8 shows a side view of the main filter element of the filter device of FIG. 1.

FIG. 9 shows a perspective view of the main filter element of the filter device of FIG. 1.

FIG. 10 shows a longitudinal section of the main filter element of the filter device of FIG. 1.

FIG. 11 shows a detail view of the longitudinal section of the main filter element of FIG. 10 in the region of the seal.

In the drawing figures, same or similar components are provided with the same or similar reference characters.

### DETAILED DESCRIPTION

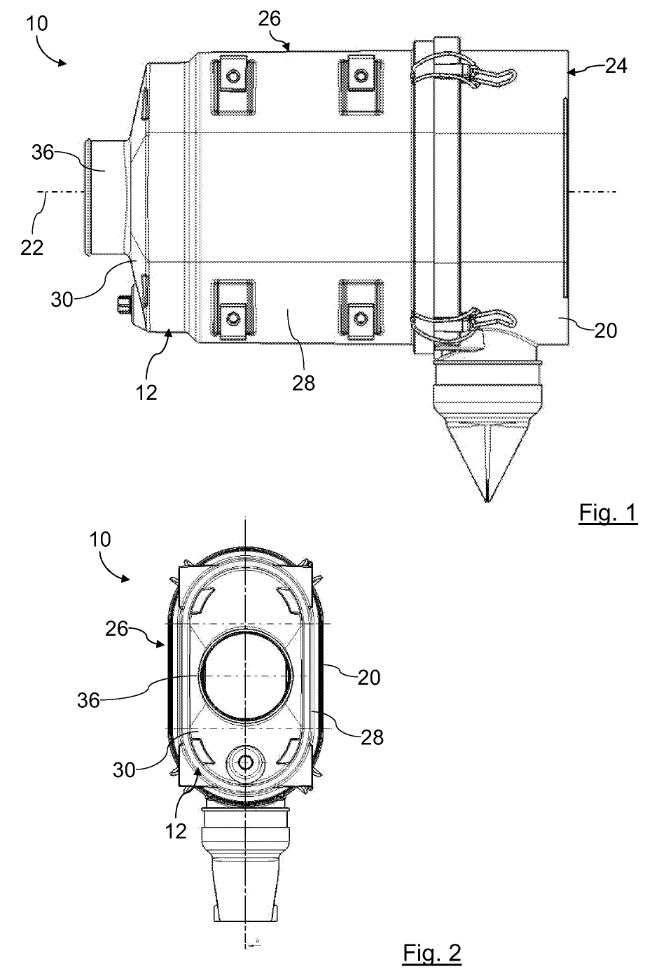

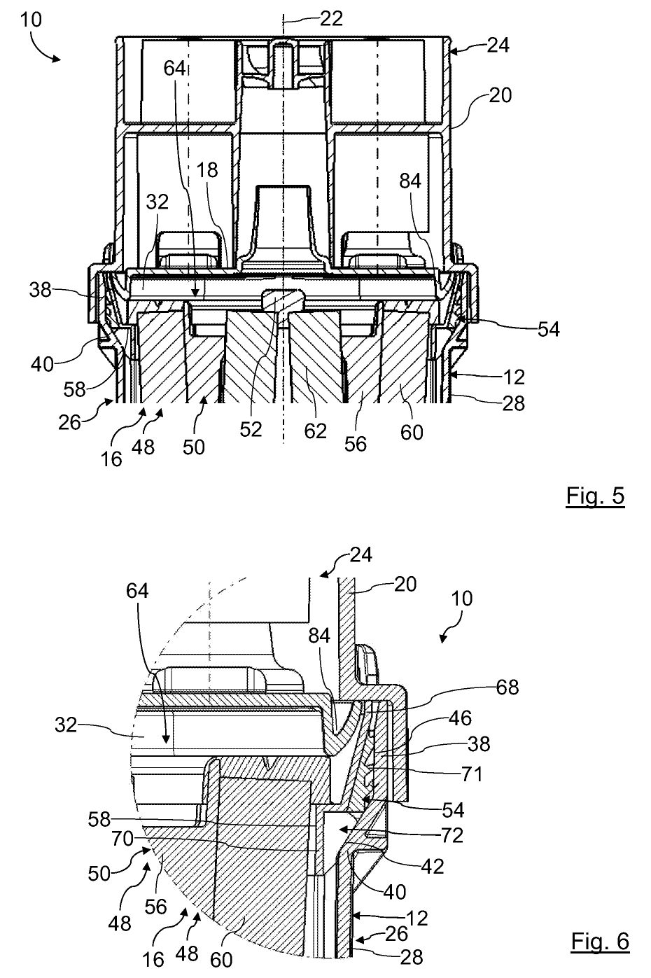

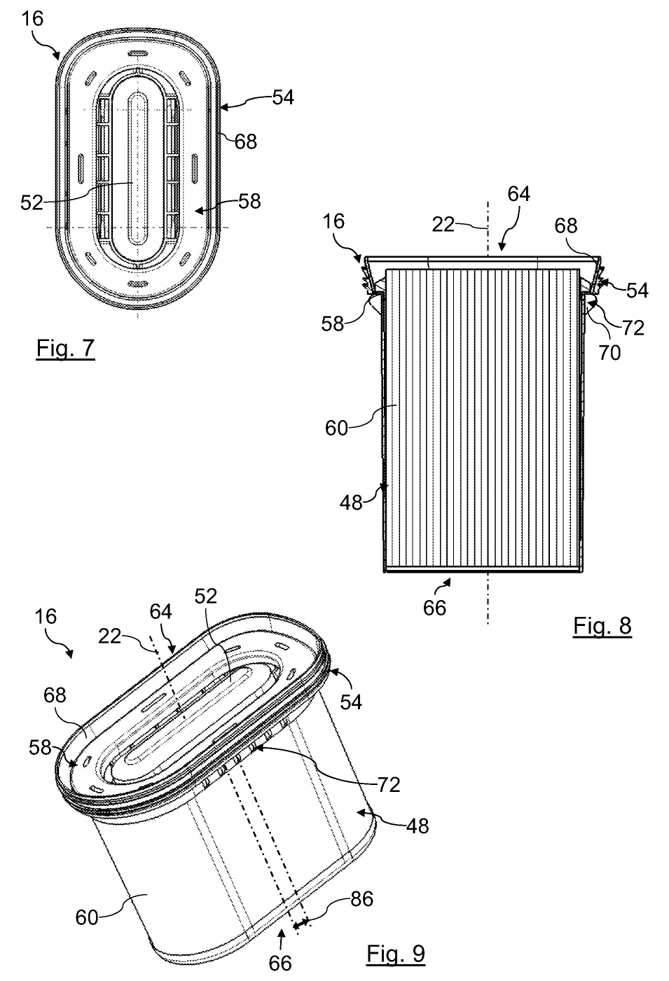

In FIGS. 1 to 11, a filter device 10 for gaseous media and its components are shown in different illustrations. Gaseous media, for example, air, may be freed from solid particles, for example, dust, by means of the filter device 10.

The filter device 10 may be used in vehicles, for example, motor vehicles, in construction and/or agricultural machines, in compressors, in connection with combustion engines, and in cathode filters, for example, in connection with fuel cells or the like.

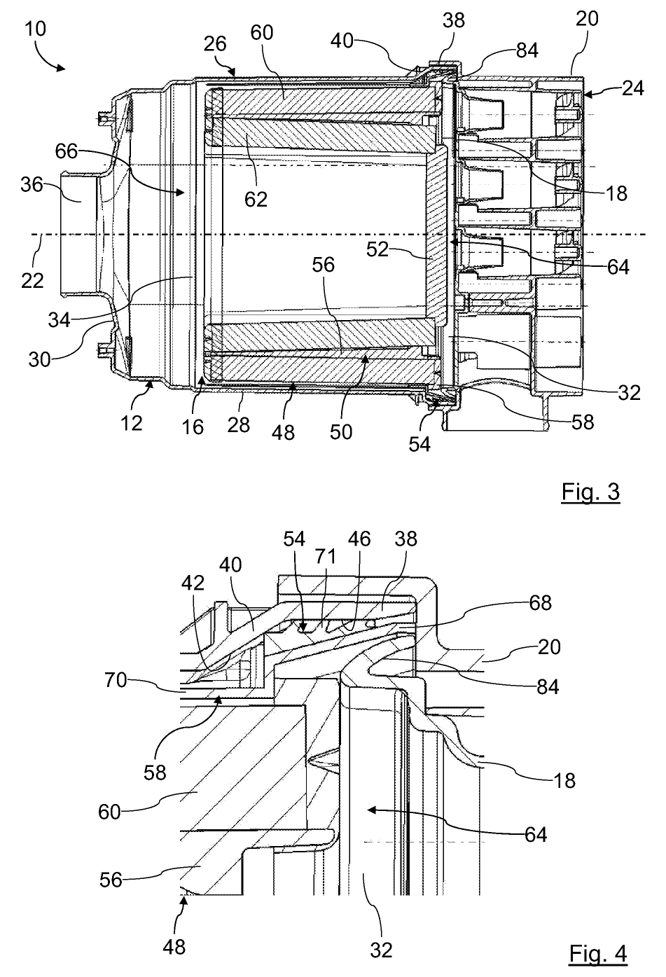

The filter device 10 comprises, as shown in FIG. 3 in an exemplary fashion, a housing pot 12, a main filter element 16, an immersion tube plate 18, and a cyclone housing 20. Furthermore, the filter device 10 comprises a post filter element not illustrated in the drawing figures. The filter device 10 as a whole is axially constructed in relation to a longitudinal center axis 22. The longitudinal center axis 22 extends in longitudinal direction of the filter device 10. The length direction of the filter device 10 is the direction in which the components of the filter device 10 are assembled. The longitudinal center axis 22 extends centrally approximately at the middle through the filter device 10.

In the following, the components of the filter device 10 and their arrangement relative to each other will be described in relation to the longitudinal center axis 22. The longitudinal center axis 22 may coincide with a housing axis of the housing pot 12, an installation/removal axis of the main filter element 16 into the housing pot 12/ from the housing pot 12, a connection axis of the immersion tube plate 18 with the housing pot 12, a connection axis of the cyclone housing 20 with the immersion tube plate 18, a connection axis of the cyclone housing 20 with the housing pot 12, an element axis of the main filter element 16, a housing axis of the housing pot 12, a plate axis of the immersion tube plate 18, and/or a housing axis of the cyclone housing 20. When in the description “radial”, “coaxial”, “axial”, “tangential”, “circumferential”, “concentric”, “eccentric” or the like is mentioned, this relates to the longitudinal axis 22, if nothing to the contrary is mentioned. In this context, “circumferential” relates to the extension of the respective virtual wall surfaces which surround the longitudinal center axis 22.

In the connected state, the immersion tube plate 18 and the cyclone housing 20 form a cyclone block 24. On the other hand, the housing pot 12 as a first housing part and the immersion tube plate 18 as a second housing part form a filter housing 26 in the connected state. When the filter device 10 is mounted, the immersion tube plate 18 is connected by means of screws to the cyclone housing 20.

The housing pot 12 is realized as one piece. The housing pot 12 is comprised, for example, of plastic material, for example, a hard plastic material.

The housing pot 12 comprises a housing wall 28 which contiguously surrounds the longitudinal axis 22. At an axial end face of the housing pot 12, a housing bottom 30 adjoins the housing wall 28. At the side which is axially facing away from the housing bottom 30, the housing wall 28 surrounds a service opening 32.

The housing wall 28 and the housing bottom 30 delimit a main filter element receiving space 34 of the housing pot 12. When the filter device 10 is assembled, the main filter element 16 is arranged in the main filter element receiving space 34. Through the service opening 32, the main filter element 16 in this context may be introduced into and removed from the main filter element receiving space 34.

An outlet socket 36 is integrated in the housing bottom 30.

The housing wall 28 comprises an elongate oval cross section perpendicular to the longitudinal center axis 22.

At the axial side with the service opening 32, the housing wall 28 comprises a collar wall 38. The collar wall 38 contiguously surrounds the longitudinal axis 22. Viewed in axial direction, the collar wall 38 has an elongate oval cross section. The collar wall 38 is radially outwardly displaced in relation to the housing wall 28.

Between the housing wall 28 and the collar wall 38, there is a collar 40. At the radially inner circumferential side, the collar 40 has a contact surface 42. The contact surface 42 forms a mating structure for projection regions 44 on the part of the main filter element 16, further explained in the following.

The contact surface 42 extends circumferentially. The contact surface 42, viewed in axial direction from the service opening 32, is inclined at an acute angle in relation to the longitudinal center axis 22.

The collar wall 38 comprises an inner wall surface 46 extending in circumferential direction at the radially inner circumferential side between its free rim and the collar 40.

The main filter element 16 comprises a filter medium body 48, a framework 50, an end body 52, and a seal 54.

The framework 50 as a whole is realized as one piece. For example, the framework 50 is manufactured as an injection-molded part. The framework 50 is made of a hard plastic material, for example.

The framework 50 comprises a central element 56 and a frame element 58.

The central element 56 serves as a support element at which filter bellows 60 and 62, explained in the following in more detail, are supported.

The frame element 58 extends contiguously in circumferential direction. The frame element 58 is located at an inflow side 64 of the filter medium body 48. The frame element 58 is connected to the central element 56 to form one piece.

The inflow side 64 is the side of the filter medium body 48 which is exposed to inflow of the medium to be cleaned, for example, air. The inflow side 64 is fluidically connected to the outlet of the cyclone block 24. An outflow side 66 of the filter medium body 48 is located at the axially opposite side in relation to the inflow side 64. The outflow side 66 is the side of the filter medium body 48 at which the medium which has been purified, for example, air, flows out of the filter medium body 48. The outflow side 66 is connected fluidically to the outlet socket 36 of the filter housing 26.

The frame element 58 comprises a seal holding wall 68 for the seal 54 and a support wall 70 for supporting the main filter element 16 in the housing pot 12. The seal holding wall 68 and the support wall 70 are connected to each other as one piece.

The seal holding wall 68 extends contiguously in circumferential direction. The seal holding wall 68 has an elongate oval extension. The seal holding wall 68 is located, viewed in an axial projection, radially outside of the radially outer wall surface of the filter medium body 48. The seal holding wall 68 surrounds the filter medium body 48 at the inflow side 64 of the main filter element 16. The seal holding wall 68 is inclined in relation to the longitudinal center axis 22. Viewed from the inflow side 64 in axial direction, an acute angle extends between the longitudinal center axis 22 and the seal holding wall 68. A free rim of the seal holding wall 68 which forms the free rim of the frame element 58 is located in relation to the longitudinal center axis 22 radially father outwardly than the axial rim of the seal holding wall 68 which is connected to the support wall 70.

The seal 54 is annular and has an elongate oval extension, viewed in axial direction. The seal 54 is located, viewed axially, between the inflow side 64 of the filter medium body 48 and the outflow side 66. The seal 54 is manufactured as one piece from an elastic material, for example, elastomer. The material of the seal 54 is softer than the material from which the framework 50 comprising the frame element 58 is formed.

The seal 54 is designed as a lamellar seal. The radially inner circumferential side of the seal 54 is fastened to the radially outer circumferential side of the seal holding wall 68, for example, glued or cast. As an alternative, the seal holding wall 68 and the seal 54 may be realized also as a two-component assembly. The circumferential seal 54 is supported at its radially inner circumferential side by the seal holding wall 68. The seal 54 is fastened indirectly by the frame element 58 to the filter medium body 48. The seal 54 is arranged completely radially outside of the radially outer wall surface of the filter medium body 48 in relation to the longitudinal center axis 22.

At the radially outer circumferential side, the seal 54 comprises three seal lips 71 in the form of lamellas as an example. Viewed from the inflow side 64 in direction of the longitudinal center axis 22, the seal lips 71 each extend at an acute angle in relation to the longitudinal axis 22 radially outwardly and in axial direction toward the inflow side 64. The seal lips 71 each extend circumferentially in a contiguous fashion.

In axial direction, the seal 54 extends from the transition of the seal holding wall 68 into the support wall 70 to a point somewhat below the free rim of the seal holding wall 68. The circumferential seal 54 protrudes past the inflow side 64 of the filter medium body 48 in axial direction. In the region of the transition into the support wall 70, the seal 54 comprises its greatest radial expansion. This means the radial expansion up to the respective base region of the seal lips 71. The radial expansion of the seal 54 decreases toward the free rim of the seal holding wall 68. The decrease of the radial expansion of the seal 54 compensates the incline of the seal holding wall 68 in relation to the longitudinal axis 22. The base regions of the seal lips 71 are located approximately at the same radial distance to the longitudinal center axis 22.

The support wall 70 extends circumferentially contiguously. The support wall 70 has an elongate oval course. The support wall 70 is located, viewed in axial projection, radially outside of the radially outer wall surface of the filter medium body 48. The support wall 70 extends along a virtual cylinder wall coaxially to the longitudinal center axis 22. The support wall 70 is radially inwardly displaced in relation to the seal holding wall 68. The transition between the support wall 70 and the seal holding wall 68 is designed as a step.

At the radially outer circumferential side of the support wall 70, a plurality of projection elements 72 are arranged. The projection elements 72 are arranged at the radially outer side of the main filter element 16 axially between the seal 54 and the outflow side 66 of the main filter element 16.

The projection elements 72 are realized as webs. Collectively, the projection elements 72 are arranged in four groups. Two of the groups are located at radially oppositely positioned long sides of the elongate oval support wall 70. The two other groups are located at radially oppositely positioned short sides of the support wall 70.

The projection elements 72 are substantially identical in relation to their shape and their size. Each projection element 72 extends from the free axial rim of the support wall 70 in axial direction up to the transition of the support wall 70 into the seal holding wall 68. The projection elements 72 each are connected at their radial inner side to the support wall 70 to form one piece. The side facing the step to the transition into the seal holding wall 68 is connected to the step and thus to the rim of the seal holding wall 68 to form one piece. The projection elements 72 each extend radially outwardly perpendicularly in relation to the radially outer side of the support wall 70. The projection elements 72 are made of the same material as the remaining framework. The projection elements 72 comprise as a whole a higher mechanical stiffness than the seal 54.

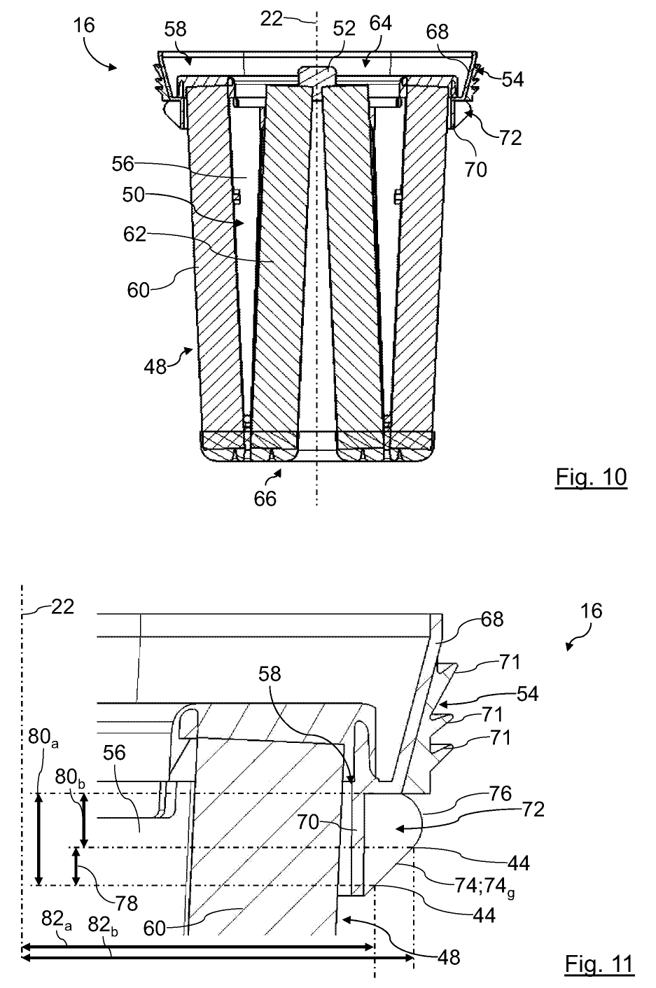

At the radially outer side, each projection element 72 comprises a support surface 74 (FIG. 11). The support surface 74 is planar. The support surface 74 extends from the free rim of the support wall 70 at the side axially facing the outflow side 66 up to the transition surface 76 in the direction toward the seal holding wall 68. The support surface 74 is inclined at an acute angle in relation to the longitudinal center axis 22.

The support surface 74 is defined by a plurality of projection regions 44. In the illustrated embodiment, innumerable projection regions 44 are provided. The projection regions 44 pass without a gap into each other.

For reasons of better clarity, only two of the projection regions 44 are identified with reference characters in FIG. 11, for example. Viewed in a projection perpendicular to the longitudinal center axis 22, the two exemplary projection regions 44 are axially spaced apart at a distance 78 in relation to the longitudinal center axis 22. The projection region 44, which is positioned closer to the seal 54, i.e., positioned at a shorter axial distance 80b, than the other projection region 44 which has a larger axial distance 80a to the seal 54, is arranged at a larger radial distance 82b to the longitudinal center axis 22 than the other projection region 44 which has a smaller radial distance 82a to the longitudinal axis 22. This correlation applies to all projection regions 44 of the projection element 72 and of the other projection elements 72.

The projection elements 72 are positioned at a distance 86 (FIG. 9) relative to each other in circumferential direction, i.e., tangential to the longitudinal center axis 22. In a projection in direction of the longitudinal center axis 22, the projection regions 44 of different projection elements 72 are tangentially spaced apart in relation to the longitudinal center axis 22.

The projection regions 44 of all projection elements 72 thus define a circumferential total support surface 74g in relation to the longitudinal center axis 22. The total support surface 74g is combined of the individual support surfaces 74 which are spaced apart from each other. The total support surface 74g is thus interrupted in circumferential direction. The total support surface 74g is inclined at an acute angle in relation to the axial direction of the longitudinal center axis 22.

The projection regions 44 of the projection elements 72, viewed in axial projection, are arranged between the longitudinal center axis 22 and a radially outer side of the seal 54. Viewed in axial projection, the seal 54 extends radially outside of the projection regions 44.

In an intended connection state of the main filter element 16 in the filter housing 26, the projection regions 44, as illustrated in FIG. 6, for example, are placed against the contact surface 42 of the housing pot 12. In this way, an axial stop of the main filter element 16 in the housing pot 12 of the filter housing 26 is formed in relation to the longitudinal axis 22. The respective support surfaces 74 are positioned in this context at least partially flat against the contact surface 42.

The transition surface 76 (FIG. 11) is bent approximately in a circular shape toward the longitudinal center axis 22. The transition surface 76 extends from the end of the support surface 74 up to the step between the support wall 70 and the seal holding wall 68. The radially outermost region of the transition surface 76 is located, viewed in axial projection, between the free end of the seal holding wall 68, at the top in FIGS. 10 and 11, and the transition of the seal holding wall 68 to the step between the seal holding wall 68 and the support wall 70.

The filter medium body 48 comprises an outer filter bellows 60 and an inner filter bellows 62. The filter bellows 60 and 62 each have a folded filter medium, for example, filter nonwoven.

The outer filter bellows 60 has the shape of a hollow truncated cone with elongate oval base surface. The outer filter bellows 60 is coaxial to the longitudinal center axis 22. The base surface of the outer filter bellows 60 is located at the side of the main filter element 16 at which also the frame element 58 of the framework 50 is located. The radially inner wall side of the outer filter bellows 60 is supported at the framework 50.

The inner filter bellows 62 has also the shape of a hollow truncated cone with elongate oval base surface. The inner filter bellows 62 is coaxial to the longitudinal center axis 22. The base surface of the inner filter bellows 62 is located at the side of the main filter element 16 which is axially opposite to the frame element 58. The radially outer wall side of the inner filter bellows 62 is supported at the framework 50.

At the side which is axially facing away from the frame element 58, the base side of the outer filter bellows 60 is connected by a connecting fold, which extends circumferentially and radially, to the base side of the inner filter bellows 62.

The end body 52 closes off an element interior surrounded by the inner filter bellows 62 at the axial end face which is facing the frame element 58. The end body 52 is manufactured, for example, of elastic material, for example, elastomer.

The immersion tube plate 18 is realized as one piece. The immersion tube plate 18 is comprised of a plastic material, for example, an injection-moldable hard plastic material. For example, the immersion tube plate 18 is produced by an injection molding method.

The immersion tube plate 18 comprises a rib 84 (FIG. 4). The rib 84 extends circumferentially contiguously coaxially to the longitudinal center axis 22. The rib 84 as a whole has an approximately V-shaped profile.

A method for assembly of the filter device 10 will be explained in the following.

The main filter element 16 is inserted with its side facing axially away from the seal 54 leading in axial direction through the service opening 32 into the filter element receiving space 34 of the housing pot 12. For this purpose, it may be necessary to rotate the housing pot 12 and the main filter element 16 relative to each other in relation to the longitudinal center axis 22.

The seal lips 71 of the seal 54 bend elastically toward the longitudinal center axis 22 upon immersion into the collar wall 38. Acting sealingly in radial direction in relation to the longitudinal center axis 22, the seal lips 71 contact the inner wall surface 46 of the collar wall 38 with the corresponding elastic pretension. The seal 54 acts so as to seal radially in the intended connection state in which the main filter element 16 is arranged in the filter housing 26.

In the completed connection state, the projection regions 44 of the projection elements 72 rest against the contact surface 42 and form in this way an axial stop of the main filter element 16 in the filter housing 26.

Subsequently, the cyclone block 24 is inserted with the immersion tube plate 18 leading in axial direction into the collar wall 38 of the housing pot 12. In this context, it may be required to rotate the housing pot 12 and the cyclone block 24 around the longitudinal center axis 22.

The free ends of the tensioning clamps, as shown in FIG. 1, are hooked behind the respective contact sections. Subsequently, the tensioning clamps are tightened. In this way, the cyclone block 24 is pushed fixedly in axial direction against the collar wall 38.

That which is claimed is:

1. A filter element comprising:
at least one filter medium body comprising an inflow side and an outflow side at oppositely positioned axial sides in relation to a longitudinal center axis of the filter element;
a circumferential seal arranged on the at least one filter medium body and extending circumferentially in relation to the longitudinal center axis;
one or more projection elements each comprising at least two projection regions, wherein the at least two projection regions are arranged at a radially outer side of the filter element axially between the circumferential seal and the outflow side, and wherein the at least two projection regions are axially spaced apart from each other;
wherein a first one of the at least two projection regions is positioned closer to the circumferential seal than a second one of the at least two projection regions and is arranged at a larger radial distance to the longitudinal center axis than the second one of the at least two projection regions;
wherein, in an intended connection state of the filter element in a filter housing, the at least two projection regions are placed against a mating structure of the filter housing to form an axial stop of the filter element in the filter housing in relation to the longitudinal center axis.

2. The filter element according to claim 1, wherein the at least two projection regions are arranged at the same projection element of the one or more projection elements.

3. The filter element according to claim 2, wherein the at least two projection regions pass without a gap into each other.

4. The filter element according to claim 1, wherein the at least two projection regions are spaced apart from each other along a circumference of the filter element.

5. The filter element according to claim 1, wherein the filter element comprises at least two of the one or more projection elements, wherein the at least two of the one or more projection elements each comprise the at least two projection regions.

6. The filter element according to claim 1, wherein the at least two projection regions define at least one support surface inclined relative to the longitudinal center axis.

7. The filter element according to claim 6, wherein the at least one support surface is a planar support surface.

8. The filter element according to claim 6, wherein the at least one support surface is inclined at an acute angle relative to an axial direction of the longitudinal center axis.

9. The filter element according to claim 1, wherein at least one of the at least two projection regions, viewed in an axial projection along the longitudinal center axis, is arranged between the longitudinal center axis and a radially outer side of the circumferential seal.

10. The filter element according to claim 9, wherein the circumferential seal extends in the axial projection radially outside of the at least one of the at least two projection regions.

11. The filter element according to claim 1, wherein all of the at least two projection regions, viewed in an axial projection along the longitudinal center axis, are arranged between the longitudinal center axis and a radially outer side of the circumferential seal.

12. The filter element according to claim 1, further comprising three or more circumferentially interrupted support surfaces distributed about an outer circumference of the filter element and facing the outflow side, wherein each one of the support surfaces is defined by at least two of the at least two projection regions.

13. The filter element according to claim 1, further comprising a frame element, wherein the one or more projection elements are arranged at the frame element of the filter element.

14. The filter element according to claim 13, wherein the circumferential seal is configured to seal at least partially radially when the filter element is arranged in a filter housing.

15. The filter element according to claim 1, wherein the circumferential seal comprises at least one seal lip.

16. The filter element according to claim 15, wherein the circumferential seal is a lamellar seal.

17. The filter element according to claim 1, wherein the circumferential seal protrudes past the inflow side in an axial direction of the longitudinal center axis.

18. The filter element according to claim 1, further comprising a seal holding wall, wherein the circumferential seal comprises a radially inner circumferential side supported at the seal holding wall of the filter element.

19. A filter housing configured to accommodate at least one filter element according to claim 1.

20. A filter device comprising at least one filter housing and at least one filter element arranged in the at least one filter housing, wherein the at least one filter element is a filter element according to claim 1.
